(19) United States
(12) Patent Application Publication
(10) Pub. No.: US 2015/0302651 A1
(43) Pub. Date: Oct. 22, 2015

(54) SYSTEM AND METHOD FOR AUGMENTED OR VIRTUAL REALITY ENTERTAINMENT EXPERIENCE

(71) Applicant: Sam Shpigelman, San Diego, CA (US)

(72) Inventor: Sam Shpigelman, San Diego, CA (US)

(21) Appl. No.: 14/690,207

(22) Filed: Apr. 17, 2015

Related U.S. Application Data
(60) Provisional application No. 61/981,696, filed on Apr. 18, 2014.
(60) Provisional application No. 62/058,611, filed on Oct. 1, 2014.

(51) Int. Cl. G06T 19/00; G02B 27/01

(52) U.S. Cl. CPC G06T 19/006; G02B 27/0172; G02B 2027/0178

(57) ABSTRACT

Augmented Reality (AR) and Virtual Reality (VR) headsets, such as the Google Glass® and Oculus Rift® systems, respectively, are poised to become significant new factors in computer environments, including gaming, virtual tourism, and the like. Such may be advantageously employed in the playback and rendering of books, and in particular audio books. Systems and methods according to present principles generally provide an audio playback experience, of an audio book, while displaying scenes pertaining to the audio book on the screen of an AR or VR system, e.g., a headset or other environment.

### CROSS-REFERENCE TO RELATED APPLICATIONS

This application claims benefit of priority of U.S. provisional patent application Ser. No. 61/981,696, filed Apr. 18, 2014, entitled “SYSTEM AND METHOD FOR AUGMENTED OR VIRTUAL REALITY ENTERTAINMENT EXPERIENCE” and U.S. provisional patent application Ser. No. 62/058,611, filed Oct. 1, 2014, entitled “VIRTUAL REALITY EXPERIENCE TIED TO INCIDENTAL ACCELERATION”, both owned by the owner of the present application and herein Incorporated by reference in their entirety.

### BACKGROUND

Books are literally one of the oldest media for providing an entertainment experience. Recently, book technology has taken a quantum leap forward with the development of e-books, both with dedicated devices as well as with applications such as Amazon's Kindle®, but the same simply replace a paper page with an electronic page, although some provide ancillary functionality such as dictionaries or the ability to take notes. Audio books are also well known, in which an audio file constituting a read-back book text is rendered for a user, such as for consumption during driving, exercising, running, walking, or the like.

Other attempts at advancing the technology of books have been made, and the development of touchscreen computing has made such efforts ubiquitous. Examples include interactive books, books that “read” themselves audibly as a child touches words or sentences, books in which a reader can choose an ending, and the like.

Still, reading tends to be a solitary experience, and from a technical perspective non-immersive.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

In one aspect, the invention is directed towards a method of providing a virtual book experience to a user, including: within a VR/AR headset, playing an audio stream representing an audio playback of a virtual book, the virtual book including two or more scenes; on a display within the VR/AR headset, displaying a first of the two or more scenes and playing a portion of the audio stream appropriate to the displayed first of the two or more scenes, the displaying of the first of the two or more scenes including displaying a left video stream for viewing by a left user eye and displaying a right video stream for viewing by a right user eye; causing a transition between the first of the two or more scenes and a second of the two or more scenes; and displaying a second of the two or more scenes and playing a portion of the audio stream appropriate to the displayed second of the two or more scenes, the displaying of the second of the two or more scenes including displaying a left video stream for viewing by a left user eye and displaying a right video stream for viewing by a right user eye.

Implementations may include one or more of the following. The audio may be played back using speakers within the VR/AR headset. The virtual book experience may be provided in the context of a virtual book file being played back by a virtual book application. The transition may include a transition selected from the group consisting of: a crossover, a fadeout/fade in, a cross-fade, a dissolve, or combinations of the above. The transition may include a theatrical transition where elements within the displayed first of the two or more scenes are sequentially removed from a virtual environment associated with the scene and where elements within the displayed second of the two or more scenes are sequentially placed into the virtual environment. The method may further include: receiving orientation data of the headset relative to a first fixed orientation; and adjusting the displaying of the first or second of the two or more scenes based on the received orientation data. The method may further include: receiving location data of the headset relative to a first fixed position; and adjusting the displaying of the first or second of the two or more scenes based on the received location data. If the location data of the headset indicates that the headset has exceeded a certain distance from the first fixed position, then the adjusting may include pausing the video or audio streams, or both. The method may further include: receiving orientation data of the headset relative to a second fixed orientation; and adjusting the playing of the portion of the audio stream of based on the received orientation data. The method may further include: receiving location data of the headset relative to a second fixed position; and adjusting the playing of the portion of the audio stream based on the received location data.

The VR/AR headset may be selected from the group consisting of: a goggles type apparatus, an eyeglasses type apparatus, or a virtual retinal display. A camera position may be associated with the displaying of the first or second of the two or more scenes, and the position may be a point of view of a character within the respective first or second of the two or more scenes. The method may further include selecting a chapter by default or receiving a selection from a user of a character whose point of view is to be adopted, and the displaying may include placing the virtual camera at the location of the selected character. The method may further include displaying an avatar associated with a user in the displayed first or second of the two or more scenes. The playing an audio stream may include receiving a live stream from a network connected source. The method may further include: displaying an avatar associated with a user in the displayed first or second of the two or more scenes; and displaying an avatar associated with a narrator in the displayed first or second of the two or more scenes, the narrator providing the live stream. The method may further include receiving an input from the user or from the narrator or user of an expression, and causing the respective avatar to perform the expression. The expression may be a facial expression or a body movement. The receiving an input may include an action selected from the group consisting of: receiving a keyboard or mouse input, receiving an input from a virtual button, receiving an input from a haptic interface, receiving an input from a camera, or receiving an input from a motion tracking system.

The method may further include receiving an input from the user to control playback of the virtual book experience. The input may be to pause the virtual book experience. The method may further include playing a background audio stream along with the audio stream representing the audio playback of the virtual book, and upon the occurrence of the pause input, pausing the audio stream representing the audio playback of the virtual book but not the background audio stream. The input may be to pause the audio stream representing the audio playback of the virtual book and the displaying of the first or second of the scenes, and the method may further include enabling the user to explore a virtual environment associated with the first or second of the two or more scenes during the pause. The enabling may include enabling the manipulation of one or more virtual objects within the virtual environment. The receiving an input may include receiving an input selected from the group consisting of: receiving a keyboard or mouse input, receiving an input from a virtual button, receiving an input from a haptic interface, receiving an input from a camera, receiving an input from a motion tracking system, or receiving an input from a user activation of a virtual element, the virtual element forming an element within the first or second scene. The virtual environment may be an online environment shared by two or more users, a 2D environment, a 2.5D environment, or a 3D environment. The providing a virtual book experience may further include providing a 4D experience, and the 4D experience may further include providing a smell or vibration detectable to the user at an appropriate portion of or location within either the audio stream or the left or right video stream. The headset may be an AR headset, and the displaying may include displaying the scenes in a scaled manner, scaled to fit on an object within view of the AR headset.

In another aspect, the invention is directed towards a VR/AR headset, including means to couple a display to the head of a user, the display including a left display for a left eye and a right display for a right eye, at least one speaker to play an audio stream, and further including a non-transitory computer readable medium, including instructions for causing the headset to perform the above methods.

Implementations may include that the headset includes removable or non-removable media storage configured to contain a media content item, or an input from streaming media.

In yet another aspect, the invention is directed towards a VR/AR device, including: a display, the display including a left display for a left eye and a right display for a right eye; at least one speaker to play an audio stream; means to couple the display to the head of a user; a display module configured to display two or more scenes, the display module further configured to display a left video stream for viewing by a left user eye and to display a right video stream for viewing by a right user eye; an audio module configured to play an audio stream representing an audio playback of a virtual book, the virtual book including two or more scenes, the audio module further configured to play back a portion of the audio stream appropriate to the displayed first or second scene of the two or more scenes; and a transition module configured to cause a transition between a first of the two or more scenes and a second of the two or more scenes.

Advantages of certain implementations of systems and methods according to present principles may include one or more of the following. Books may be read in a new and interesting way. Using VR/AR technology in combination with the disclosed methods and systems, computationally efficiency may be increased, e.g., as opposed to where the same are rendered on multiple displays for stereoscopic viewing.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a schematic depiction of a VR headset according to present principles.

FIG. 2 illustrates an arrangement of scenes according to present principles.

FIG. 3 illustrates another arrangement of scenes according to present principles.

FIGS. 4A and 4B illustrate yet other arrangements of scenes according to present principles.

FIG. 5 is an exemplary flowchart of a method according to present principles.

FIG. 6 is another exemplary flowchart of a method according to present principles.

FIG. 7 is another exemplary flowchart of a method according to present principles.

Like reference numerals relate to like elements throughout. Elements are not to scale unless otherwise noted.

### DETAILED DESCRIPTION

Augmented Reality (AR) and Virtual Reality (VR) headsets, such as the Google Glass® and Oculus Rift® systems, respectively, are poised to become significant new factors in computer environments, including gaming, virtual tourism, and the like. Such may be advantageously employed in the playback and rendering of books, and in particular audio books. Systems and methods according to present principles generally provide an audio playback experience, of an audio book, while displaying scenes pertaining to the audio book on the screen of an AR or VR system, e.g., a headset or other environment.

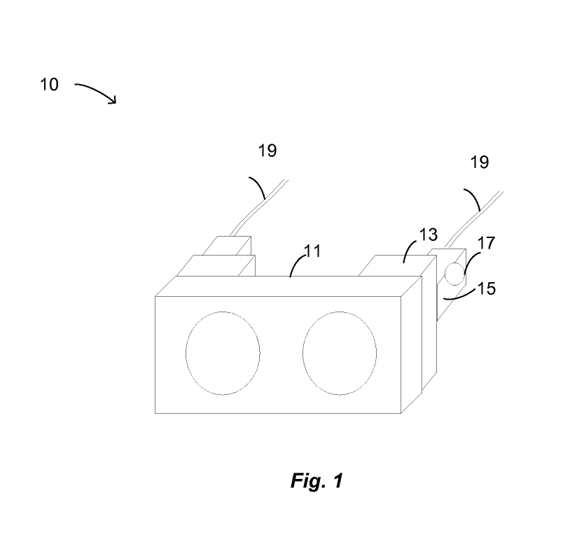

The systems and methods will be described in the context of a virtual reality or augmented reality headsets, but it will be understood that the same principles apply to other virtual or augmented reality devices and environments, such as eyeglasses, e.g., Google Glass® or other eyeglass products. Referring to FIG. 1, one implementation of the virtual reality headset 10 generally includes a video display portion 11, a head conforming portion 13, and an audio portion 15 in which one or more (generally two, one on each side) speakers 17 may be situated, either permanently or inserted or placed therein by the user. A strap 19 holds the system to the user's head. The strap 19 is shown schematically; generally a strap goes over the top of the user's head as well, which bears much of the weight of the headset.

In another implementation of a device according to present principles, the headset is worn like a pair of glasses, with a bridge connecting lens frames and temples securing the lenses to the head, and thus there is no need for a strap or head conforming portion. In yet another implementation, the system according to present principles may be implemented as part of a virtual retinal display, where images and video are projected as light directly onto the retina, thus forming images directly on the user's eyes. Generally systems and methods disclosed here may be employed in combination with future display technologies, so long as the same are capable of forming an image interpretable by a user, even if the interpretation is being performed at the level of the user's visual cortex.

The VR/AR headset may have its own sound playback systems, i.e., may have permanently installed sound renderers or speakers, while others require insertion of a headset or ear buds. Systems and methods according to present principles generally require that sound be capable of being played back in one of these forms, or via similar means. Preferably, the sound is played back in a stereo fashion, to accommodate anisotropic sound production, and thus greater user immersion through user-deduced sound location and user-deduced sound movement as will be described in greater detail below.

The headset 10, and in particular the video display portion 11 and audio portion 15, receive transmitted signals from a computing environment, the same pertaining to video and audio portions of the book. The audio portion of the book is the read-back audio of the text, and the video portion provides additional appertaining content, as will be described below. The signals are generally rendered by the computing environment. It will be understood that as technology advances, systems and methods according to present principles may become entirely self-contained, with data storage, rendering, and display or play back occurring on the VR or AR headset. The self-contained nature may be via a removable or nonremovable media within the headset itself. In this regard it is also noted that a virtual book application may playback a virtual book file, or a self-contained virtual book application may itself include the file along with the player.

In systems and methods according to present principles, i.e., according to implementations of the present invention, an audio book file or files are played back while a user is wearing a VR/AR headset or is otherwise within a VR/AR environment. For example, the audio book file may be played back while the user is in another immersive environment, which is not coupled to their head, e.g., an immersion chamber or room. For convenience, in this application, while the term “VR/AR headset” is employed, it will be understood that a non-headset VR/AR environment is also contemplated. In this case, the user may be wearing headphones or earbuds, or speakers may be on the wall of the virtual reality environment. However the virtual reality is achieved, while the audio book file is rendered, scenes appropriate to or reminiscent of the rendered content are portrayed on the VR/AR headset.

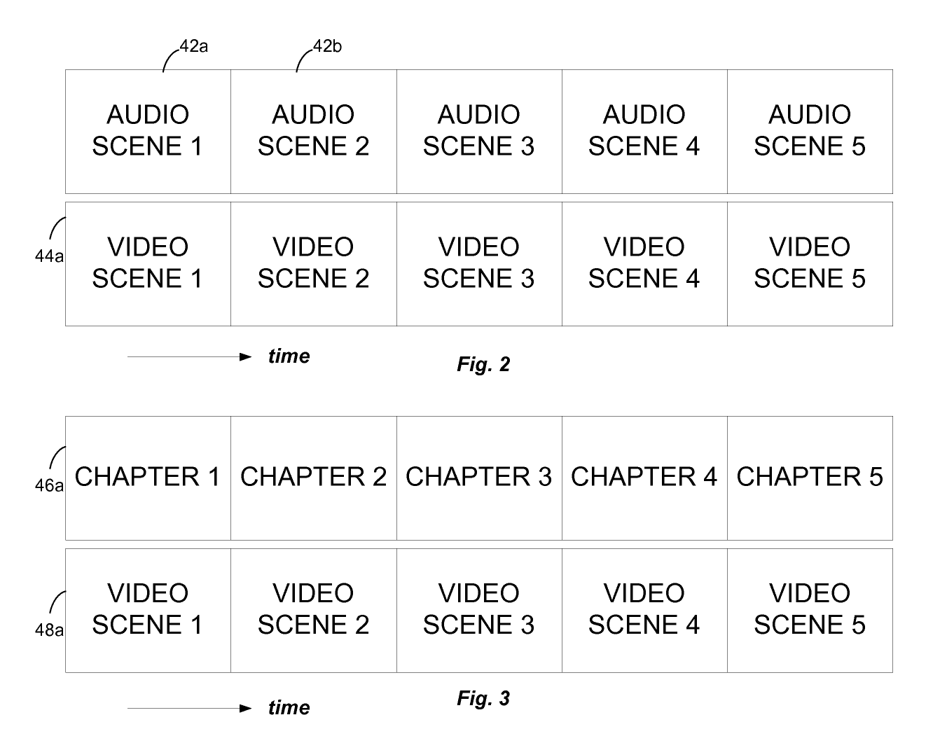

In more detail, the VR/AR headset may be configured to display scenes reminiscent of the played back audio content, including in a 2-D fashion or in a 3-D fashion, contemporaneously with the playback of the audio. However displayed, it is useful to have the scene move as the user moves, as described in greater detail below. FIG. 2 illustrates a scheme in which audio scenes 1-5 (elements 42a, 42b, etc.) are directly synchronized with corresponding respective video scenes 1-5 (44a, etc.). FIG. 3 illustrates a scheme in which the audio scenes correspond to chapters (46a, etc.), which are again directly synchronized with corresponding respective video scenes 1-5 (48a, etc.). In some cases a book may be broken up into chapters, while in other cases, particularly children's books, there will be no such division.

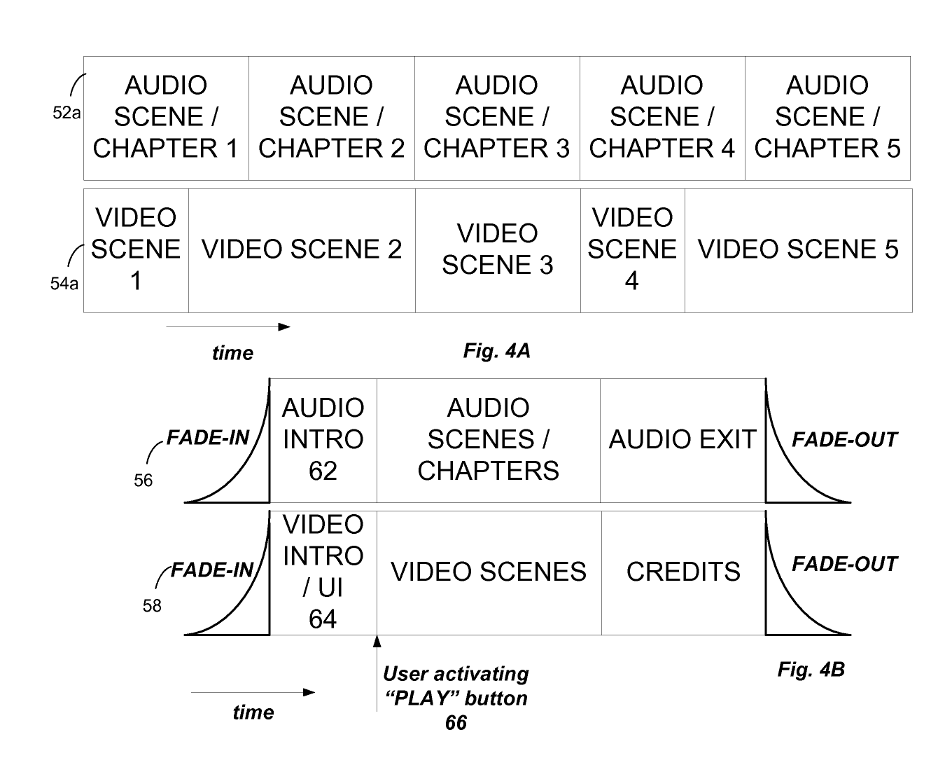

As noted in the figures, an x-axis is understood which corresponds to time. FIG. 4A illustrates a use case in which video scenes 54 overlap various audio scenes 52. Such may be the case where a particular video scene is common to the end of one chapter and the beginning of the next. Such may also be the case where the designer of the book presentation believes the flow or needs of the story dictate a common setting between audio scenes for chapters. Numerous variations will be understood to one of ordinary skill in the art, including where one chapter has multiple audio and video scenes within.

FIG. 4B illustrates a common situation in which, after initiation, instantiation, or activation of a ‘book’ according to current principles, audio and/or video is faded in with a fade in segment 56 and 58, respectively, and an initial screen 64 (and initial audio 62) is presented, which may have audio such as background music or the like, audio of publication or bibiliographic information, an introduction, promotional material, advertisements, or the like. The screen generally has a UI overlay with various elements allowing a user to adjust settings, such as languages, as well as a “PLAY” button 66 to allow the book reading and video display to start. Upon a user activating “PLAY”, the audio scenes and video scenes may be played back and displayed as noted above. At the end, an ‘exit’ may be provided, in both audio and video, allowing presentation of credits or ancillary or auxiliary content, accompanied by background music, commentary, or the like. It will be understood that fade-outs, cross-fades, and other transitions may also be employed.

Transitions between video scenes may be performed in a number of ways, including using standard transitions such as fade-outs and fade-ins, dissolves, crossovers, and the like. However, video transitions may also be performed in a way similar to the theater transitions, in which items are “pushed away” and “pulled out”, as if from a backstage location. Such may even be accompanied by audio sounds of moving furniture. Alternatively, the entire scene may simply move to one direction or another, and be accordingly replaced by the next scene.

An important aspect of certain implementations is that the user may advantageously employ the VR/AR functionality to become immersed in the novel art form of book presentation. For example, VR/AR headsets are often equipped with movement and motion sensors, such that the VR/AR headset can send a signal corresponding to whether (and by how much) a user is rotating their view of a scene, or even if the user is moving from one location to another (longitudinally or translationally) within a scene. Generally, unless the user is walking in the room, the longitudinal or translational movement will only correspond to, e.g., the user sitting up or leaning forward. However, systems and methods according to present principles can also be employed where users are walking on a treadmill, walking within a room, or otherwise moving, e.g., on an exercise bike or stepper or elliptical, or on a device especially designed for such movement, e.g., the Virtuix Omni®. Systems and methods according to current principles may then adjust the view according to the user movement or motion. The adjustment may be both visually and aurally, the latter being accomplished by dynamic sound leveling.

For example, in a book presentation of Anna Karenina, a train scene may be displayed, with characters talking on a platform or in a station. By movement or motion of the user's head, the user may more preferentially hear the conversation, train noises, or the like. For example, if a user tilts their head towards speaking character, or turns their head towards them, the conversation may become louder or more clear. If the user tilts their head towards the train, or points their head in that direction, train noises may become more clear or louder. Of course, by turning their head toward characters or toward the train, a view of the characters or the train will also occupy more of the user's virtual or augmented reality environment, i.e., the user will see the people or the train more preferentially or clearly.

Such dynamic sound leveling may be accomplished in various ways, and the same generally involve determining an area of the environment in which the user is focusing or otherwise providing attention to, and adjusting the sound accordingly. This sort of determination of an area or point at which a user is focusing or otherwise providing their attention may include determining a direction of a user center of view (e.g., by ray casting, defining collision objects, or other techniques). Once the user center of view is determined, the audio effect of audio-generating objects at various locations with respect to the user center of view may be calculated and rendered to the user accordingly.

In this way, a user's experience of an audio book is enhanced, making the experience significantly more immersive.

The point of view of the “reader” (listener) may be dynamic or static. In other words, the view may stay the same with respect to the scene for the duration of the scene, or the user may be able to affect the view by movements of their head.

The point of view of the user may also vary according to user preference. For example, the user may choose to adopt the point of view of one of the characters in the scene. Alternatively, the user may choose an option where the same “lurks” around the scene as an observer. Various point of view options may be offered to the user. If the user chooses a particular character as their point of view, and the character is not in a subsequent scene, the system may default to a “non-character” point of view or may switch the point of view to that of another character (provisions may be made for the user to choose several characters, which may be prioritized in a list, whose points of view they are interested in). It will be understood that such a prioritized list may also be provided by default, e.g., by the virtual book designer.

In some implementations, immersion may be better perceived and served by having the user represented by an avatar within the online environment. In some views the user may see their avatar (e.g., over the shoulder), and in other cases the user “sees” the online environment through the avatar's eyes. The default placement for an avatar may be set by a virtual book designer to accommodate for a meaningful experience considering the location of the user and the scene or online environment, and multiple options may be provided for the placement. The avatar may be customized for the user in body, makeup, or dress, the former by appropriate image mapping as known and the latter by the same or by various period dress appropriate for the book's setting and predefined by the virtual book designer. Other variations will also be understood.

Users may also be provided with ancillary, pop-up, or picture-in-picture scenes when the streaming content is such that a description of another location is being expressed. For example, if the playback alludes to another city, an inset or pop-up (including, e.g., as a cartoon bubble) may appear with a small or thumbnail image of the city. Numerous other variations will also be understood. Phone conversations may be depicted with a split screen, as is known, but places, objects, or people discussed by the phone conversation participants may be depicted in such insets or pop-ups, where such insets or pop-ups include video, audio, animations, or other such images.

In a method according to present principles, first steps generally involve the installation and loading or other such instantiation of the virtual or augmented book application, and subsequent loading of a particular book to be experienced, or by instantiation of an app which provides the VR experience and also provides the content itself, as described in greater detail below. In some cases, the virtual reality experience according to present principles will be streamed, or only a certain portion will be preloaded and stored (followed by subsequent display) locally, at the VR/AR headset, or at a storage location in communication with the VR/AR headset.

It is further noted in this context that a “virtual book” as contemplated in the present disclosure may be represented by a distinct application, downloadable or streamable to a computing environment such as a desktop computer, laptop computer, tablet computer, mobile device, AR/VR headset, and so on. A virtual book may also be a file or streamable content which is playable using a virtual book application, the virtual book application being loadable or resident on the computing environments described above. In some cases all the distinct content of the virtual book, e.g., scenes, audio narration or other voiceovers, and the like, are present in the file or streamable content. In other cases, the file or streamable content accesses a library of scenes resident on the local system, e.g., accessible or within the virtual book application (e.g., commonly used content, scenes of famous cities). In yet other cases, the file or streamable content represents only visual scenes or a visual stream, as well as an audio stream, for playback on the VR/AR headset, with little or no processing being performed locally.

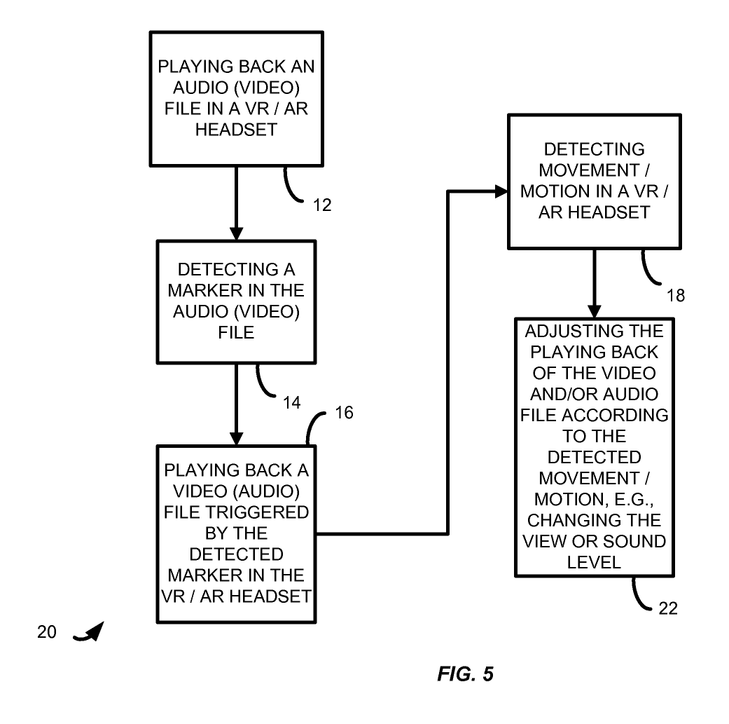

These steps may be followed by user selection of a “PLAY” button or the like. Following such, and referring now to a first embodiment illustrated by the flowchart 20 of FIG. 5, a next step is generally the rendering of an audio file in a VR/AR headset (step 12). When the audio file is first played back, a default scene may be visually rendered in the VR/AR headset, the default scene and subsequent scenes generally being displayed in a 3-D environment so that as a user's head moves, the scene can be adjusted in a way that suggests to the user that relative movement has taken place, increasing the immersive effect. It is noted that such is very different from simply portraying a scene on a computer screen, where movement of the user's head has no effect. The audio file has incorporated certain markers which serve as scene cues. Thus, once such a marker is detected in the audio file (step 14), a video file is played back or displayed which is triggered by the detected marker (step 16). Generally, the display of the video file will include the loading of a 3-D model of the scene into graphics memory to which the VR/AR headset has access, such as that of a computing environment, mobile device, or even within the VR/AR headset itself. The user can “look around” the 3-D scene, and to a certain extent (the extent being how much of the scene has been re-created in the CG model) can move around within the scene.

Submarkers may then be employed to move the scene forward. In the example above, a submarker may indicate when the train is pulling up to the station, and the portrayed scene may then seamlessly transition to that point. In some cases, depending on the length of the book, some 3-D models of scenes may be viewed by the user for a long period of time; however, the user's interest may be maintained by the ability to move their head or body to “look around” or explore the scene. In some cases, if a user has caused playback, they may still be enabled to “look around” and explore the scene.

The above embodiment noted that the video scene was cued by markers in the audio file. However, the reverse may also occur: the video scene may be played back and used to trigger the playback of one or more audio files by which the book is read. This embodiment is illustrated in FIG. 5 by the parenthetical notations. This implementation may be particularly appropriate for children's books, where text is displayed. Upon the occurrence of the time marker in a video playback, text may appear, accompanied by audio narration or audio reading of the text. This implementation allows additional interactivity, as text is not made to flow unceasingly. The user, e.g., child, can dwell on a particular text for a while, can be enabled to play mini games, can “click on” or activate various buttons within the interface to access additional content, or the like.

It will further be understood that in the above embodiments, the underlying playback file, audio or video, may be keyed to time. That is, time may flow in an absolute fashion, and events in the audio or video file is keyed to certain time markers. The other file, video or audio, respectively, may then be keyed to the other of the files. Moreover, in another implementation, only an initial event, audio or video, need be triggered by an absolute time marker—some or all subsequent events may be keyed to relative time markers, based in some way on the absolute time marker.

Moreover, the audio or video files need not necessarily be keyed to each other. In one implementation, both the audio and video files are keyed to absolute time (or as noted above, absolute time plus relative time, where absolute time represents a total time elapsed from the beginning of play back, and relative time indicates a time measured from an event, not necessarily the beginning of play back).

In yet another variation, the audio file and the video file (or both) may be divided into two or more portions, e.g., a background portion and a narrative portion. In some implementations, if a user has paused playback, such may cause a pausing in the narrative portion, but the background portion may be allowed to persist and provide an interesting environment for a user. For example, a user may wish to pause narrative playback and just explore a scene. In some cases such exploration may lead to the discovery of elements that move the story forward or give the user additional information. In the case where the user has pressed a pause button during a transition, the transition may be allowed to finish before the scene pauses.

In a particularly advanced implementation, motion capture and/or tracking hardware may be fitted to a user's hand, or held in a user's hand, and may be employed to allow the user to pick up and use certain items within a scene. For example, if a letter is an element in a scene, following a character's (audio) reading of the letter, the user may be allowed to pick up the letter and read it again (visually) while the rest of the story progresses (aurally). In other implementations of the above example, the playback of the audio content, e.g., the reading of the story, may be paused until the reader is finished with the letter.

Returning to FIG. 5, sensors in the VR/AR headset may then be employed to detect movement or motion by the user, and to send a signal to the system upon such detection (step 18). The rendering of the video and/or audio file may then be adjusted according to the detected movement or motion or both (step 22).

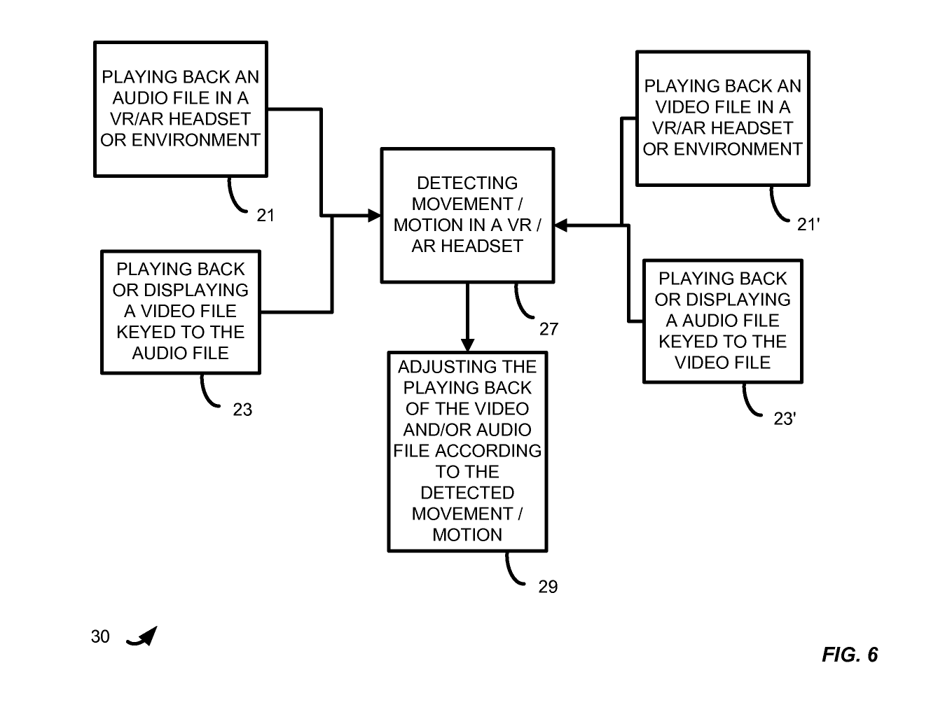

FIG. 6 depicts an alternate implementation of systems and methods according to present principles. In FIG. 6, an audio file is rendered by the audio renderers in a VR/AR headset (step 21). At the same time, a video file which is keyed to the audio file is rendered in the VR/AR headset (step 23). A difference between this implementation and that of FIG. 5 is primarily in the data structure. In FIG. 5, markers and sub markers are employed to cue 3-D scenes and transitions. In FIG. 6, the audio file and video information are “matched up” at every point, and thus no triggering is necessary. FIG. 6 may also indicate the situation in which both the audio file and the video file are skewed based on time, rather than on markers in one or the other file. Further, while the above description is for the application where a video file is keyed to an audio file, the reverse situation is illustrated by the same enumerated steps, with primed numerals.

The remainder of the implementation is as above, i.e., movement or motion is detected (step 27), and the rendering of the video and/or audio is adjusted accordingly (step 29).

The above description has referred to an audio book file being played back, but the same may be replaced by streamed content, such as when a book is being read aloud in one location contemporaneously with a remote playback of the “read aloud” sound on a VR/AR headset, the same again coupled with displayed scenes appropriate to or reminiscent of the streamed content. This system may be advantageously employed when a reader is away from the person read to, e.g., when a parent is in the military and deployed, or when a grandparent reads to a grandchild who is at a remote location.

In certain such implementations, both the reader and the person being read to may be equipped with VR/AR headsets, and each may “see” their own presence in the online environment by use of an avatar. Similarly, they may each view the other's presence in the online environment by viewing the other's avatar. The default placement for the avatars may be set by a virtual book designer to accommodate for a meaningful experience considering the location of a reader (narrator) to a user, and in some implementations multiple options for such placement may be available and enabled. Both the reader (narrator) and the user (read to) may view each other's avatars from their individual points of view, similar to a multiplayer game.

Avatars may in some cases be enabled to convey human emotions via facial expressions and body language. To accomplish this, UI elements may be provided in which a user can select emotions to convey on their avatars. In more advanced implementations, facial tracking or camera systems may be employed to directly convey the facial expressions of the person reading to an avatar viewable by the person being read to, e.g., viewable by an avatar of the person being read to, where the point of view of the person being read to is that of their avatar. In a specific implementation, avatars' facial expressions may be predefined by virtual book designers, and specific actions such as hand gesticulations may be captured by video tracking equipment, caused by the pressing of a specific button on a keyboard or other input mechanism, or via an eyegaze tracker. Such techniques may be employed to trigger the execution of facial expressions. The same can be used to perform specific body language expressions.

It should be noted that in some cases one or the other of the reader or the person being read to may be represented by an avatar but may not have a VR/AR headset in which to be immersed in the virtual reality environment. Such person may still provide inputs to an avatar expression system, e.g., via any of the techniques noted above, to provide feedback to the other person.

In these implementations, the person reading may also be provided with a display of text so that they are aware of what to read. Alternatively, the person reading may view the scene through an AR type of headset, e.g., Google Glass®, and thus be able to read words on a book while still viewing this scene viewed by the user, and thus able to interact with the same by the use of avatars, etc.

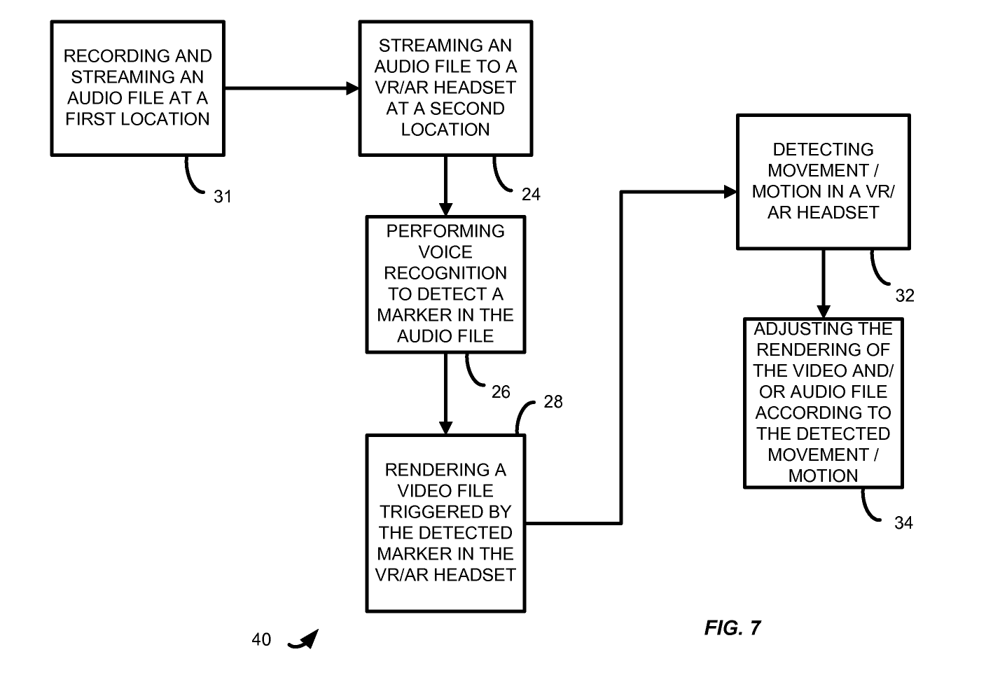

This implementation is depicted by the flowchart 40 of FIG. 7. In a first step, an audio file is recorded at a first location (step 31). The audio file is streamed to a VR/AR headset at a second location (step 24). Voice-recognition may be performed on the streamed audio file in order to detect certain markers (step 26). For example, upon the system detecting that the phrase “Chapter 2” has been read, the scene may shift to that appropriate to chapter 2 of the book. Alternatively, the reader may provide such an indication on their end, e.g., activating a button on a user interface to indicate that the scene should shift. Books may even be provided with notations to indicate to the reader when the scene transition activation button should be activated.

In some implementations, e.g., if the reader is reading from an e-book, the act of turning to a particular page may indicate to the system that the scene transition should occur, e.g., to the 3-D model appropriate to the scene portrayed on the given page.

Once markers or other devices are detected in the audio file, the same may be used as a trigger to display the video file (step 28) and to cause transitions and movements within. The remainder of the implementation is as above, i.e., movement or motion is detected (step 32), and the display or play back of the video and/or audio is adjusted accordingly (step 34).

It will be understood that hybrid systems may also be employed, e.g., an audio book may be played back with the prerecorded narration, but streamed or otherwise transmitted “live” audio or content may be transmitted along with the pre-recorded narration, or at pauses or other prespecified times within the prerecorded narration.

It is further noted in the above embodiments that while the description is particularly related to streaming, and thus providing a “live” reading experience, the audio file may also be pre-recorded and streamed or downloaded to the location of the VR/AR headset.

### Variations

Variations will be understood. For example, while the implementations described above indicate generally automatic transitions from one 3-D model of a scene to the next, the user may override such automatic transitions and remain “within” one 3-D model even while the story progresses (aurally) to the next, particularly if they find the one 3-D model particularly intriguing or interesting, or wish to explore it more.

In another variation, motion tracking devices as noted above, which can be fitted to or held by a user, may be employed to “turn pages” in the sense of “turning scenes”; in other words, a user may cause scenes to be moved from one to the next by a hand motion. Such may be appropriate for children's books in which text may be displayed.

Children's books may also provide a degree of interactivity. For example, virtual buttons may be provided that the user may “press” to allow certain actions to occur. This implementation may be particularly appropriate in augmented reality implementations, in which such buttons may not only be displayed but the system may also be enabled to “view” user activations of such buttons. Adult books may also provide a degree of interactivity, especially for textbooks and instructional books. But even in teen or adult fiction books, interactivity may allow for a user to pick up and read a letter, to explore a room, or to perform other actions. In the simplest input technique for such interactivity, a user simply provides keyboard, touchpad, or mouse input. In more advanced techniques, video cameras or the like may be employed to allow visual inputs to affect operation and thus afford a degree of interactivity. In yet other more advanced techniques, haptic input devices may allow the user to interact with their environment. Other such interactivity techniques are described below in connection with 4D environments.

In another implementation, a multiple-choice question (or several) may be portrayed on a screen following the reading of a chapter or other section of a book, and virtual buttons on an augmented reality (or virtual reality) screen may be employed for the user to select from among the multiple choices, as well as to display a result of the selection.

Hand motions may also cause playback of the book to pause or perform other trick play. For example, at the end of a chapter or other audio scene, a user may be allowed to explore the virtual scene (e.g., pick up articles discussed in the text, explore buildings or characters, etc.) until such a time as they wish to move forward in the book, and a hand gesture (or button activation, in the case of no motion tracking) may be employed to “turn the scene”. Other technology may also be employed to provide user input functionality, including voice-recognition and voice processing technology. For example, a user may provide voice input such as “re-read last sentence”, “open menu”, or “re-read last paragraph” or the like.

In one variation, which may be particularly appropriate for violent scenes depicted in books according to present principles, a degree of separation may be situated between the user (and/or the user's avatar) and the violence in the scene. For example, the user's avatar may be situated on a couch, in a theater, behind the stage, or in some other “capsule zone” visually separated by some transition from the action in the scene. In this way, the immersive effects of the headset will not cause discomfort to the user, as the user will be reminded that they are not in the scene with the violence.

In yet another variation, user input may be accomplished by gaze tracking, and thus determining where a viewer is looking. For example, a gaze tracker may be instantiated by a user pressing a button, e.g., on the headset or on a keyboard or mouse, at which point a virtual button portrayed on the user interface (within the headset) and detected as being gazed at (e.g., as a center of view) by the viewer may be highlighted. Detection of gaze, or a direction at which a user is looking, may be via known techniques, such as are implemented within the military and automotive industries, e.g., for use by pilots to track targets using eye tracking systems, as well as for use in high-end automobiles to detect driver fatigue by tracking a driver's eyes.

Blinking or other activations including keyboard or mouse button depressions may cause the “virtual button” to then be depressed. Similar actions may occur with sliders or the like. In this way, the use of just a single physical button may allow control of the content stream playback, easing use of keyboards or computer mice and also allowing use of single button devices such as iPads, iPhones, and other mobile devices. Such physical buttons, e.g., one or potentially two or more for complicated interfaces, may further itself be provided on the headset.

In yet another variation, instead of a gaze tracker, the system may define any position on the user interface, on the perpendicular bisector of positions defined by the lenses or the user's eyes, as being intended to be highlighted by the user. In other words, a center of view of the user (assuming the user's eyes are looking forward) may be used as a pointer. Such may be determined in practice by ray casting, defining collision objects, or other techniques.

In these above techniques of visual focus control, the center of visual interest may act as a pointer like a mouse. The same can be depicted by a crosshair or a dot or via another type of indication, or may simply be detected by the consequent highlighting of the virtual button, menu item, or other activatable element. Confirmation of activation or highlighting of a button may be performed using an audio signal such as a small beep.

In another variation of the user interface, the user interface controlling playback may be integrated as part of the scene in the environment of the book. For example, if the scene takes place on a mountain, buttons such as “play”, “pause”, and the like, may be implemented by or within trees or rocks on the mount. Numerous other variations will also be understood. Alternatively, the user interface may be static with respect to the direction the user is facing, and may thus appear in the same place on the screen irrespective of the direction the user is facing or pointing.

Other variations will also be understood. For example, while 3-D models in portrayed scenes may provide additional, auxiliary, or ancillary content to the read aloud book, such may be generally provided to enhance the experience. For example, a nature scene may accompany a book of “Spring” poetry. On the other hand, horror novels may be accompanied by knocking, creaking, or other spooky audio content, as well as sudden appearances of visually rendered ghosts or the like, startling the user.

So-called “4D” content may be included to further enhance the immersion experience, where such 4D content may be employed to provide sensations to senses besides sight and hearing. For example, in one implementation vibration devices may be incorporated within the headset or within motion capture or tracking hardware to provide vibration effects at desired times. Smells may be provided by a bank, matrix or set of aromatic capsules, which can be combined in various ways and secreted to yield desired aromas. For example, nature scenes may be accompanied by pine scents, and so on. In another implementation, sources of heat or cold are employed to provide temperature effects. Other variations, and combinations of such techniques, will also be understood.

Besides 2D, 3D, and 4D content as described above, so-called “2.5D” content may also be provided, in which two-dimensional images or animations are disposed on planes which are themselves two-dimensional, but which may pass one in front of the other to provide movement and a limited sense of depth. Generally an orthographic camera is employed to view such planar imagery.

Various use cases of 2.5 D content may be understood. In one, the visual elements of a scene can be 2D or 3D but the action may be restricted to one or more planes, where a plane is defined by two axes, e.g., a vertical axis and a horizontal axis. Visual elements in this case can move only vertically and horizontally, and movement of the visual elements closer to or further away from the camera is prohibited. In this case, the camera movement may also be restricted to horizontal or vertical movement and in most cases, the rotation of the camera is prohibited. Most often in this case a perspective camera is employed, although in some cases orthographic or other cameras may be used.

In another case, the visual elements of a scene can be 2D or 3D but the action may be restricted to a circumference surrounding the camera (with the camera location acting as a center), with the camera separated from the circumferential area along a vertical direction. Increasing or decreasing the circumference, thus bringing visual elements closer or further away from the camera, is generally not allowed. In this case, the position of the camera is restricted to vertical movement and in most cases, the rotation of the camera is restricted by rotation around a vertical axis (in conventional horizontal scenes). Most often in this case a perspective camera is employed, although in some cases orthographic or other cameras may be used.

Content portrayed in books using systems and methods according to present principles may be abridged or unabridged. In some cases, abridgment may occur because the visual portrayal of the scene means that a textual description of the scene is no longer necessary or warranted.

Textbooks may benefit from the systems and methods according to present principles, as the aspects read about may be portrayed visually, including the depiction of a dynamic graphs or figures or other animations, including that of historical or literary reenactment. In children's books, e.g., learning the alphabet may include learning about the letter “A” accompanied by a picture of an apple or an alligator. The apple or alligator may be manipulated by the child, increasing their interest and subsequently increasing their desire to learn. In more advanced texts, other dynamic scenes may include anatomical structures, engineering models, chemical and biomolecular models, how proteins are connected, what happens when such biological and chemical structures are split, and other scientific data. Language learning may benefit from systems and methods according to present principles, in which read-aloud words may be portrayed on the screen along with their translations or with visual images pertaining to their definition. Other variations will also be understood.

In yet another variation, users may be enabled to create their own stories to share with others, e.g., family members, friends, or for marketing and distribution generally. In this case, VR/AR apps may be created in which authors will be enabled to create supporting VR/AR worlds to accompany their stories. Such apps will include 3-D scene creation tools, generally with a library of pre-created scenes appropriate for many genres of stories, along with a module or other means for recording audio. The pre-created scenes may include westerns, sci-fi, fantasy, metropolitan scenes, and so on. In some cases 3-D scenes may be created from 2-D images, e.g., family photographs, using known techniques.

In yet another variation, a calibration routine may be performed. In particular, a calibration procedure may be performed to help the virtual book application or device to determine the normal (face forward) position of a reader's headset. Such a routine or procedure may be performed before every reading session, and the system may be re-calibrated at any time per the user's request. For example, calibration can be achieved by asking a reader to sit straight and face forward, or otherwise attain a comfortable position, and then prompting for activation of a button (mouse, keyboard, etc. to record a normal position. This position may be considered as a normal/default position and orientation when the virtual world of a book is instantiated.

It is noted that various distinctions exist between the virtual books as described above and standard video games. In particular, video games provide an active experience by mandating player's participation. In other words, to experience a game, one must play it. Virtual books provide a more passive experience. In addition, the video game experience is competitive in its nature, even if one is just playing against oneself, while the virtual book experience is not. All games present players with designed choices that solicit players to act. The actions lead to a quantifiable outcome within a system of meaningful play that in turn helps to determine players' progress with respect to winning and losing conditions. Books on the other hand do not have such winning or losing conditions. Finally, in many games, players may choose to progress differently to reach a winning condition (the end of a game). This experience is termed non-linear. Books present a more linear experience, although in some cases a degree of interactivity may be provided.

In another variation, the system can be capable of recognizing user's movement such as forward, backwards, side, up and down. This movement is different from user's head movement such as tilting and turning. If a significant amount of user movement is detected, a safety may be triggered to prevent the user from continuing viewing the virtual/augmented reality book. This can be done in a form of book pause, fade to black, white or any other color, warning sign or text, etc., in any combination. The system may then require user's input to resume the viewing experience. This aspect provides an important safety feature in that the user may be effectively prohibited from viewing while walking around. It is note that some AR/VR devices are capable of recording small directional movements due to user's leaning forward, backwards, side to side, up and down. Such movements should not stop the book viewing experience. If the player stands up, starts walking, etc., on the other hand, these moves may generally pass a pre-defined movement threshold and the above mentioned safety mechanism may be triggered. Implementation of the safety mechanism may be via a number of techniques, including GPS, accelerometer, Bluetooth® (including by detecting if the user exceeds a certain distance away from a computer), and so on.

In yet another variation, virtual or augmented reality books may use aspects of the outside environment to determine or suggest control. That is, they may synchronize to either pre-defined markers (visual markers, beacon markers such as WIFI, Bluetooth, and other types of signals), or via other techniques may synchronize to elements of the environment that surround the user.

User may also choose the elements of the environment to synch the augmented reality book to, and may scale the augmented reality book to a desired size. Automatic scaling may also be provided as an option. In this implementation, for example, the user may see the book appear atop a desk or table, providing a ‘stage’ or the like for the action to play out on. Such may be particularly powerful in AR, as the scene may play out on an actual desk or table in front of the user. Other implementations will also be understood, e.g., a user at the Acropolis or Parthenon may see a Greek play re-enacted in AR. In converting the scene viewed in an arbitrary or designer-set way in a VR/AR headset to one viewed on a tabletop or other physical (or virtual) object, a homographic transformation may be employed to situate and scale the scene to within the confines of the physical or virtual object.

The methods shown and described above may be implemented in one or more general, multi-purpose, or single-purpose processors. Unless specifically stated, the methods described herein are not constrained to a particular order or sequence. In addition, some of the described methods or elements thereof can occur or be performed concurrently. It is further noted that configuring the systems in the ways described can lead to significant computational efficiency not otherwise gained. The systems and methods may be implemented in a computer, in which case the programming of the computer would render the computer a special purpose device, with the purpose being the virtual book experience. Such a computer may be coupled to a VR/AR headset or glasses, in a wired or wireless fashion. Alternatively, all of the computing and rendering power necessary to implement the virtual book experience may be situated within the VR/AR headset or glasses. Such may further include input means for user interaction, e.g., gaze trackers, haptic controllers, motion trackers, e.g., incorporating cameras so as to recognize hand motions as input motions, e.g., for trick play, or the like.

Functions/components described herein as being computer programs are not limited to implementation by any specific embodiments of computer programs. Rather, such functions/components are processes that convey or transform data, and may generally be implemented by, or executed in, hardware, software, firmware, or any combination thereof

It will be appreciated that particular configurations of the operating environment may include fewer, more, or different components or functions than those described. In addition, functional components of the operating environment may be implemented by one or more devices, which are co-located or remotely located, in a variety of ways.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be construed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

The system and method may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, are loaded into random access memory. Inputs to the application, e.g., from the plurality of users or from any one user, may be by any number of appropriate computer input devices. For example, users may employ a keyboard, mouse, touchscreen, joystick, trackpad, other pointing device, or any other such computer input device to input data relevant to the calculations. Data may also be input by way of an inserted memory chip, hard drive, flash drives, flash memory, optical media, magnetic media, or any other type of file-storing medium. The outputs may be delivered to a user by way of a video graphics card or integrated graphics chipset coupled to a display such as the VR/AR headset that maybe seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or wi-fi-connected device downloads a copy of the application to their device from a server using a wireless Internet connection. An appropriate authentication procedure and secure transaction process may provide for payment to be made to the seller, and appropriate DRM may be applied to the virtual book application or to individual virtual books or both. The application may download over the mobile connection, or over the WiFi or other wireless network connection. The application may then be run by the user. Such a networked system may provide a suitable computing environment for an implementation in which a plurality of users provide separate inputs to the system and method. In the above system where channel surfing is contemplated, the plural inputs may allow plural users to input relevant data at the same time.

1. A method of providing a virtual book experience to a user, comprising:
a. within a VR/AR headset, playing an audio stream representing an audio playback of a virtual book, the virtual book including two or more scenes;
b. on a display within the VR/AR headset, displaying a first of the two or more scenes and playing a portion of the audio stream appropriate to the displayed first of the two or more scenes, the displaying of the first of the two or more scenes including displaying a left video stream for viewing by a left user eye and displaying a right video stream for viewing by a right user eye;
c. causing a transition between the first of the two or more scenes and a second of the two or more scenes; and
d. displaying a second of the two or more scenes and playing a portion of the audio stream appropriate to the displayed second of the two or more scenes, the displaying of the second of the two or more scenes including displaying a left video stream for viewing by a left user eye and displaying a right video stream for viewing by a right user eye.

2. The method of claim 1, wherein the audio is played back using speakers within the VR/AR headset.

3. The method of claim 1, wherein the virtual book experience is provided in the context of a virtual book self-contained application or a virtual book file being played back by a virtual book application.

4. The method of claim 1, wherein the transition includes a transition selected from the group consisting of: a crossover, a fadeout/fade in, a dissolve, or combinations of the above.

5. The method of claim 1, wherein the transition includes a theatrical transition where elements within the displayed first of the two or more scenes are sequentially removed from a virtual environment associated with the scene and wherein elements within the displayed second of the two or more scenes are sequentially placed into the virtual environment.

6. The method of claim 1, further comprising:
a. receiving orientation data of the headset relative to a first fixed orientation; and
b. adjusting the displaying of the first or second of the two or more scenes based on the received orientation data.

7. The method of claim 1, further comprising:
a. receiving location data of the headset relative to a first fixed position; and
b. adjusting the displaying of the first or second of the two or more scenes based on the received location data.

8. The method of claim 7, wherein if the location data of the headset indicates that the headset has exceeded a certain distance from the first fixed position, then the adjusting includes pausing the video or audio streams, or both.

9. The method of claim 1, further comprising:
a. receiving orientation data of the headset relative to a second fixed orientation; and
b. adjusting the playing of the portion of the audio stream of based on the received orientation data.

10. The method of claim 9, further comprising:
a. receiving location data of the headset relative to a second fixed position; and
b. adjusting the playing of the portion of the audio stream based on the received location data.

11. The method of claim 1, wherein the VR/AR headset is selected from the group consisting of: a goggles type apparatus, an eyeglasses type apparatus, or a virtual retinal display.

12. The method of claim 1, wherein a camera position associated with the displaying of the first or second of the two or more scenes is a point of view of a character within the respective first or second of the two or more scenes.

13. The method of claim 12, further comprising selecting a chapter by default or receiving a selection from a user of a character whose point of view is to be adopted, and wherein the displaying includes placing the virtual camera at the location of the selected character.

14. The method of claim 1, further comprising displaying an avatar associated with a user in the displayed first or second of the two or more scenes.

15. The method of claim 1, wherein the playing an audio stream includes receiving a live stream from a network connected source.

16. The method of claim 15, further comprising:
a. displaying an avatar associated with a user in the displayed first or second of the two or more scenes; and
b. displaying an avatar associated with a narrator in the displayed first or second of the two or more scenes, the narrator providing the live stream.

17. The method of claim 16, further comprising receiving an input from the user or from the narrator or user of an expression, and causing the respective avatar to perform the expression, wherein the expression is a facial expression or a body movement.

18. The method of claim 17, wherein the receiving an input includes an action selected from the group consisting of receiving a keyboard or mouse input, receiving an input from a virtual button, receiving an input from a haptic interface, receiving an input from a camera, or receiving an input from a motion tracking system.

19. The method of claim 1, further comprising receiving an input from the user to control playback of the virtual book experience.

20. The method of claim 19, wherein the input is to pause the virtual book experience.

21. The method of claim 19, further comprising playing a background audio stream along with the audio stream representing the audio playback of the virtual book, and upon the occurrence of the pause input, pausing the audio stream representing the audio playback of the virtual book but not the background audio stream.

22. The method of claim 21, wherein the input is to pause the audio stream representing the audio playback of the virtual book and the displaying of the first or second of the scenes, and further comprising enabling the user to explore a virtual environment associated with the first or second of the two or more scenes during the pause.

23. The method of claim 22, wherein the enabling includes enabling the manipulation of one or more virtual objects within the virtual environment.

24. The method of claim 19, wherein the receiving an input includes receiving an input selected from the group consisting of: receiving a keyboard or mouse input, receiving an input from a virtual button, receiving an input from a haptic interface, receiving an input from a camera, receiving an input from a motion tracking system, or receiving an input from a user activation of a virtual element, the virtual element forming an element within the first or second scene.

25. The method of claim 1, wherein the virtual environment is an online environment shared by two or more users, a 2D environment, a 2.5D environment, or a 3D environment.

26. The method of claim 1, wherein the providing a virtual book experience further comprises providing a 4D experience, and wherein the providing a 4D experience further comprises providing a smell or vibration detectable to the user at an appropriate portion of or location within either the audio stream or the left or right video stream.

27. The method of claim 1, wherein the headset is an AR headset, and wherein the displaying includes displaying the scenes in a scaled manner, scaled to fit on an object within view of the AR headset.

28. A VR/AR headset, including means to couple a display to the head of a user, the display including a left display for a left eye and a right display for a right eye, at least one speaker to play an audio stream, and further comprising a non-transitory computer readable medium, comprising instructions for causing the headset to perform the method of claim 1.

29. The headset of claim 28, further comprising removable or non-removable media storage configured to contain a media content item, or an input from streaming media.

30. A VR/AR device, comprising:
a. a display, the display including a left display for a left eye and a right display for a right eye;
b. at least one speaker to play an audio stream;
c. means to couple the display to the head of a user;
d. a display module configured to display two or more scenes, the display module further configured to display a left video stream for viewing by a left user eye and to display a right video stream for viewing by a right user eye;
e. an audio module configured to play an audio stream representing an audio playback of a virtual book, the virtual book including two or more scenes, the audio module further configured to play back a portion of the audio stream appropriate to the displayed first or second scene of the two or more scenes; and
f. a transition module configured to cause a transition between a first of the two or more scenes and a second of the two or more scenes.
